(19) United States
(12) Patent Application Publication
(10) Pub. No.: US 2005/0273312 A1
(43) Pub. Date: Dec. 8, 2005

(54) Distriubte USB KVM switch

(76) Inventors: Francisc Sandulescu, Bucuresti (RO); Adrian Bica, Solon, OH (US); Justin Thomas Gierke, Lakewood, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/860,888

(22) Filed: Jun. 3, 2004

(51) Int. Cl. G06F 9/455

(52) U.S. Cl. 703/25; 703/23

(57) ABSTRACT

The present invention relates to a system and method for switching USB keyboard and mouse interfaces and video interfaces between host interfaces over extended distances. Provided is a distributed KVM switch where a USB keyboard and mouse is emulated to the host interfaces of the KVM switch and a USB host is emulated to keyboard and mouse interfaces of the KVM switch. In addition, the USB keyboard and mouse interfaces and the video interfaces are separated from the host interfaces by a non-USB communications channel.

### FIELD OF THE INVENTION

The present invention relates to communication with keyboard, mouse, and video devices and, more specifically, to a system and method for switching keyboard, video, and mouse connections between hosts and extending the distance between hosts and keyboard, video, and mouse connections.

### BACKGROUND OF THE INVENTION

A keyboard, video, and mouse switch (KVM switch) allows a keyboard, video display monitor, and mouse to be switched to any of a number of computers. KVM switches are designed to connect keyboard and mouse devices to keyboard and mouse input ports of host computers. When switching keyboard and mouse devices between hosts, it may be desirable for it to appear to the host that the keyboard and mouse are always connected, even when they have been “switched” to another host. This “emulation” enables auto-boot functionality and translation.

Recently, keyboard and mouse devices, as well as other peripherals, have moved more toward Universal Serial Bus (USB) technology. USB is a peripheral bus standard developed by the PC and telecom industry, including Compaq, DBC, IBM, Intel, Microsoft, NEC and Northern Telecom. USB defines a bus and protocols for the connection of computer peripherals to computers (and computers to each other). “Universal Serial Bus Specification,” Compaq, Intel, Microsoft, NEC, Revision 1.1, Sep. 23, 1998, describes USB and its implementation and is incorporated herein by reference. In addition to standard USB devices and technologies, a new USB standard 2.x now exists. “Universal Serial Bus Specification,” Compaq, Hewlett-Packard, Intel, Lucent, Microsoft, NEC, Philips, Revision 2.0, Apr. 27, 2000 describes the most current USB 2.x standard and its implementation and is incorporated herein by reference. The USB 2.x standard permits faster data transmission than the USB 1.x standard.

Proposed and actual USB devices include keyboards, mice, telephones, digital cameras, modems, digital joysticks, CD-ROM drives, tape and floppy drives, digital scanners, printers, MPEG-2 video-based products, data digitizers, and other devices. USB protocol supports the dynamic insertion and removal of such devices from the bus (or “hot-plugging”) and recognizes actual peripherals or “functions”; hosts (typically a computer); and hubs, which are intermediate nodes in the network that allow the attachment of multiple downstream hubs or functions. Upon insertion of an downstream hub or function, the host/hub on the upstream side of the bus initiates a bus enumeration to identify and configure the new device. Upon removal, the removed device is “forgotten.”

Due to the stringent electrical signal requirements of USB standard specifications, it is difficult to meet the electrical specifications for USB signaling using simple amplifiers or special cable. Accordingly, a USB cable longer than about 5-10 meters generally will not work, even when using active terminations. In part, extending USB cables beyond about 5-10 meters is difficult because signal symmetry and skew can become compromised. It would be preferable if USB devices could be connected by a technology that permits the devices to be more than about 5-10 meters from a host.

One method of increasing the distances between a USB device and a host is to use signal translation to convert USB signals into an alternate signal capable of traveling more than 10 meters without distortion. Unfortunately, even if a USB signal is translated such that the electrical specifications are met, the USB timing specifications may limit the length of the extender to about 50-80 meters. According to USB 1.x standards, answers to messages originating from a host must be received within about 1333 nanoseconds (ns) or the host will generate an error. The 1333 ns includes the time required for the message to travel from the host to the peripheral device (referred to as the host to device trip time); the time required for the device to answer the host; and the time required for the message to travel from the device to host (referred to as the device to host trip time). Also according to USB 1.x standards, the trip time (host to device and/or device to host) is specified to be not longer than 380 ns.

Therefore, one can calculate the length of an extender to be 126 meters in an ideal case where there is no time required for the device to answer the host and where the cable transmits data at the speed of light. Typically, circuitry introduces delay of about 100 ns and the signal speed for common cables is about 1 meter per 5 ns, compared to the speed of light which is about 1 meter per 3 ns. Thus, for a “transparent” USB extender (referring to an extender that merely translates or converts signals from USB-type signals to another type of signal and back to USB-type signals) one can calculate a maximum limit of about 55 meters.

To extend USB signals beyond this calculated limit (about 55 meters), a different type of USB extender may be required. In order to prevent the generation of an error by the host due to response delay, a USB extender can be configured to immediately answer the host with a “not acknowledge” (NAK) response while sending the message to the device and awaiting the device's response. Upon receipt of the NAK response, the host will retry the original message about one millisecond later. When the host attempts to send the message again, the answer (from the device) may have been received by the extender and be immediately available for delivery to the host. While this type of USB extender allows for longer extensions, it decreases the available bandwidth, it is not transparent, and its implementation in both hardware and software is complex. Further, some USB devices and/or host drivers may not work with this type of extender.

Another method for extending USB signals beyond the calculated limit involves host and device emulation. In this configuration, the extender appears to the USB host as a USB keyboard and mouse. Any requests from the USB host will be answered by the extender. The data and requests will then be sent via the extender to the USB keyboard and mouse. The extender appears to the USB keyboard and mouse as a USB host. Similarly, data sent from the USB keyboard and mouse will be sent to the USB host via the extender and any necessary replies to the keyboard and mouse will be generated by the extender.

As USB devices become increasingly more popular, the need to switch and extend USB keyboard and mouse devices becomes more pressing. Therefore, it may be preferable if a KVM switch were capable of switching USB keyboard and mouse devices while extending the distance between the USB keyboard and mouse devices and a USB host.

### BRIEF SUMMARY OF THE INVENTION

According to one aspect of the invention, there is provided a distributed KVM switch that includes: a non-USB channel; a host unit communicably coupled to the non-USB channel and at least one USB host and video source, the host unit including a plurality of sets of host interfaces, each set of host interfaces having a host keyboard and mouse interface and a host video interface, and a device unit communicably coupled to the non-USB channel and at least one USB keyboard and mouse and video display, the device unit including a plurality of sets of KVM interfaces, each set of KVM interfaces having a USB keyboard and mouse interface and a video interface, and a master controller configured to switch at least one of the sets of KVM interfaces among the host interfaces; wherein a USB host is emulated to each of the USB keyboard interfaces and mouse interfaces; and wherein a USB keyboard and mouse are emulated to the host interface.

According to another aspect of the present invention, there is provided a distributed KVM switch that includes: an at least four-pair non-USB communications channel for transmitting USB data and video data; and a host unit communicably coupled to the non-USB channel and at least one USB host and video source. The host unit includes: a plurality of sets of host interfaces, each set of host interfaces having a host keyboard and mouse interface and a host video interface, at least one computer controller communicably coupled to at least one of the sets of host keyboard and mouse interfaces, the computer controller being configured to emulate a USB keyboard and mouse, and a host controller configured to control data flow over the non-USB channel. The distributed KVM switch also includes a device unit communicably coupled to the non-USB channel and at least one USB keyboard and mouse and video display. The device unit comprises: a plurality of sets of KVM interfaces, each set of KVM interfaces having a USB keyboard and mouse interface and a video interface, at least one user controller communicably coupled to at least one of the USB keyboard and mouse interfaces, the user controller being configured to emulate a USB host, and a device controller configured to control data flow over the non-USB channel. The distributed KVM switch further comprises: a video switch communicably coupled to at least one video interface and to at least one host video interface and configured to switch the video interfaces between the host video interfaces; and a master controller communicably coupled to the video switch and configured to switch at least one of the sets of keyboard, mouse and video interfaces between the host interfaces.

Also according to the present invention, there is provided a method for switching keyboard, mouse and video signals over an extended distance between a video source and a monitor and between a host device and a keyboard and mouse. The method includes: receiving at a device unit USB keyboard and mouse commands; receiving at a device unit video data from a video display; emulating a USB host to the keyboard and mouse; receiving a switching command at a master controller, the switching command containing identification information; converting the received keyboard and mouse commands to a non-USB format suitable for transmission over a non-USB communications channel; transmitting to a host unit the non-USB commands and video data via a non-USB communications channel; receiving at the host unit the converted commands and video data via the non-USB communications channel; converting the commands received via the non-USB communications channel to USB commands for transmission over a USB communications channel; using the identification information to determine the destination host for the USB commands and the destination video source for the video data; transmitting the USB commands to a USB host via a USB communications channel; and transmitting the video data to a video source via a video communications channel.

### BRIEF DESCRIPTION OF THE DRAWINGS

FIG. 1 is a block diagram of a system with a distributed KVM switch;

FIG. 2 is a block diagram of the device unit of the distributed KVM switch;

FIG. 3 is a block diagram of the host unit of the distributed KVM switch;

FIG. 4 is a flow chart generally illustrating part of the data flow when switching keyboard and mouse devices and video data over an extended distance; and

FIG. 5 is a flow chart generally illustrating another part of the data flow when switching keyboard and mouse devices and video data over an extended distance.

### DETAILED DESCRIPTION OF THE INVENTION

The present invention relates to a system and method for switching and extending KVM interfaces between host interfaces. Provided is a distributed KVM switch where a keyboard and a mouse are emulated to host interfaces of the KVM switch and hosts are emulated to keyboard and mouse interfaces of the KVM switch.

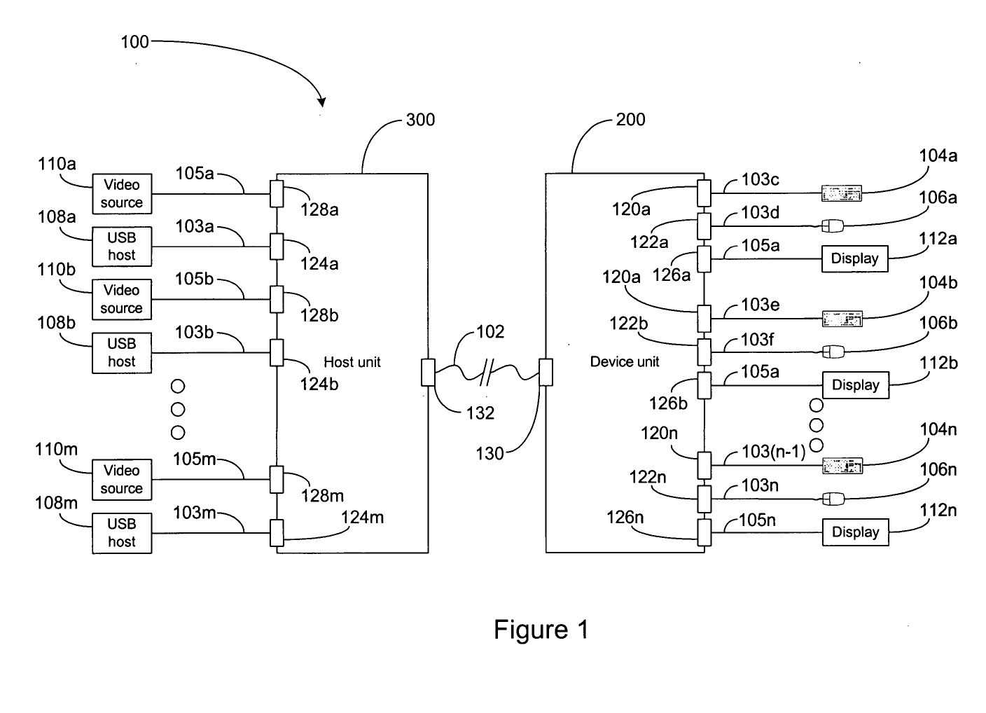

Turning initially to FIG. 1, a block diagram of a system with a distributed KVM switch is illustrated. The distributed KVM switch 100 is generally positioned between and connectable to at least two USB hosts 108x and at least two sets of USB user input devices, each set including a keyboard 104x and mouse 106x. The distributed KVM switch 100 generally includes a device unit 200, a host unit 300 and a non-USB communications channel 102. The distributed KVM switch 100 may be compatible with USB 1.x, USB 2.x, or both. The hosts 108x may be any USB hosts and are each connectable to the host unit 300 via a USB communications channel 103x. The keyboard 104x and mouse 106x are also connected to the device unit 200 via a USB communications channel 103x.

The device unit 200 is connectable to the host unit 300 via a non-USB communications channel 102. Generally, the device unit 200 is configured to receive USB commands from the keyboard 104x and mouse 106x via the keyboard interface 120x and mouse interface 122x, convert the received commands to non-USB commands, and transmit the received commands to the host unit 300 via the non-USB communications channel 102, and switch the keyboard and mouse interfaces 120x and 122x, respectively, between USB host interfaces 124x of the host unit 300. The device unit 200 may also be configured to receive non-USB commands from the host unit 300 via the non-USB communications channel 102, convert the received commands to USB commands, and transmit the converted commands to the keyboard 104x and mouse 106x via the keyboard and mouse interfaces 120x and 122x.

The device unit 200 is also connectable to a video display 112x via a video communications channel 105x. The device unit 200 is configured to receive video data from the video display 112x via the video interface 126x and prepare and transmit to the host unit 300 the received video data over the non-USB communications channel 102. The device unit 200 may also be configured to receive video data from the host unit 300 via the non-USB communications channel 102 and prepare and transmit the received video data to the video display 112x via the video communications channel 105x.

Generally, the host unit 300 is connectable to the host 108x via a USB cable 103x and is configured to convert the non-USB commands received via the non-USB communications channel 102 to USB commands for transmission to a host 108x. The host unit 300 is also configured to transmit to the host 108x the converted USB commands via the USB host interface 124x. The host unit 300 may also be configured to receive USB commands from the host 108x via the USB host interface 124x, convert the received USB commands to non-USB commands, and transmit the converted non-USB commands to the device unit 200 via a non-USB communications channel 102.

The host unit 300 is also connectable to a video source 110x via a video communications channel 105x. The host unit 300 is configured to receive video data from the device unit 200 via the non-USB communications channel 102 and prepare and transmit the received video data to the video source 110x. The host unit 300 may also be configured to receive video data from the video source 110x via the video communications channel 105x and prepare and transmit to the device unit 200 the received video data over the non-USB communications channel 102.

The non-USB communications channel 102 may be any type of non-USB communications channel, such as a wire-based category 5 (CAT5) communications channel or wireless communications channel. Such communication channels include, for example, Ethernet, Token-Ring™, 802.11-type wireless data transmission, or other wire-based or wireless data communication mechanisms as will be apparent to one of ordinary skill in the art. In an exemplary embodiment, a RS485 communications channel provides a non-USB communications channel 102. RS485 is useful as a non-USB communications channel 102 because RS485 meets the requirements for a multi-point communications network and can withstand “data collisions” (bus contention) problems and bus fault conditions. Further, RS485 hardware can detect the start-bit of the transmission and automatically enable (on the fly) the RS485 transmitter. Once a character is sent the hardware can revert back into a receive mode within about 1-2 microseconds. Any number of characters can be sent, and an RS485 transmitter is capable of automatically retriggering with each new character. In addition, a bit-oriented timing scheme can be used in conjunction with network biasing for fully automatic operation with a communications specification. Because delays are not required, the distributed KVM switch 100 may be capable of longer data transmission (and thus longer extensions) than if other non-USB communications channels 102 were utilized.

In an exemplary embodiment, the non-USB communications channel 102 is at least a four pair communications channel. Three of the pairs may be used to transmit video image data and one of the pairs may be used to transmit USB data. In addition, video device data may also be multiplexed, such as time multiplexed, with USB data and transmitted via the one pair. For non-USB communications channels 102 having more than four pairs, video device data may also be transmitted via an additional pair. The video device data may be Display Data Channel (DDC) data, or the like. DDC is a standard created by the Video Electronics Standard Association (VESA) that allows control through software of the settings of a graphical terminal, such as a monitor. For the purpose of the present invention the video image data can be switched using any video switch. Accordingly, only the keyboard, mouse, video device data and peripheral switching capabilities are detailed herein. It will be understood that the distributed KVM switch includes a video switch communicably coupled to the video image data path configured to switch the video interfaces 126x between the host video interfaces 128x. The video image data can be switched either concurrently or independently with the keyboard and mouse through the use of technology known in the art. Any video switching technology known in the art may be used. In addition, each set of KVM interfaces [check for number] includes a keyboard interface 104x, a mouse interface 106x, and a video interface 112x and each set of host interfaces includes a USB host interface 124x and a host video interface 128x.

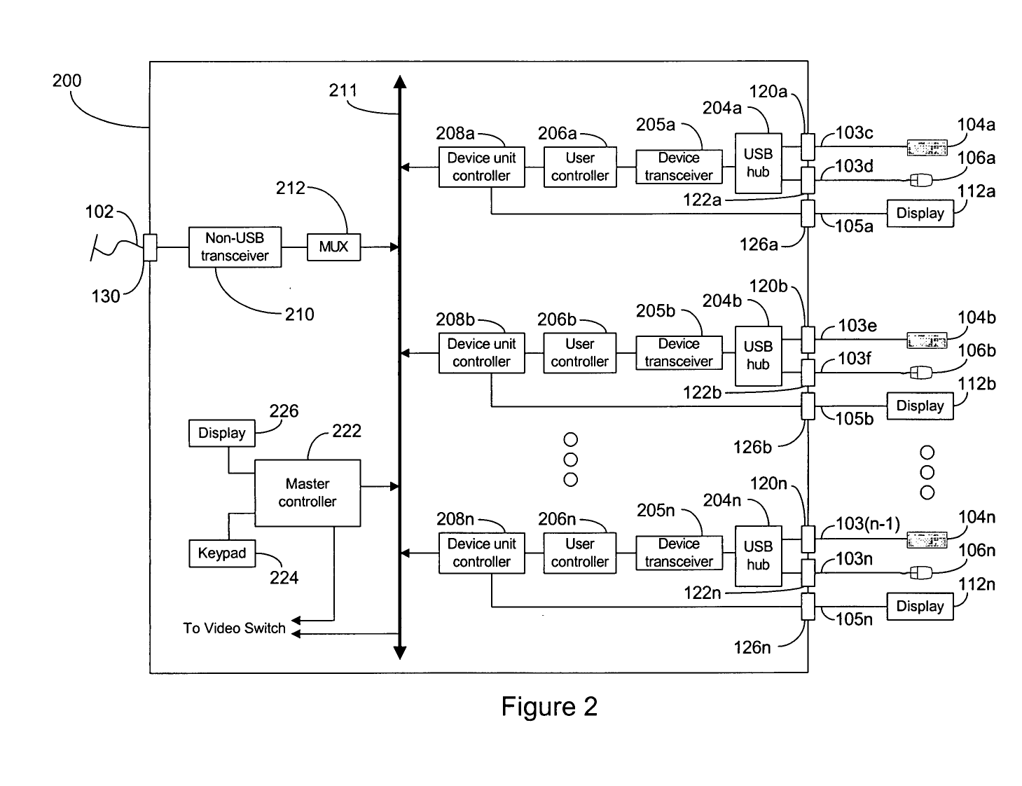

Referring first to the keyboard and mouse data path, turning to FIG. 2, each keyboard interface 120x and mouse interface 122x are communicably coupled to a corresponding USB hub 204x. The USB hub 204x is configured to enable full speed signaling of messages through the distributed KVM switch, even if all the devices connected to the switch are low speed.

The USB hub 204x is connected to a USB device transceiver 205x. The USB device transceiver 205x may be a circuit implementing the physical layer for the transmission protocol, such as a USB 2.0 PHY or the like. The USB device transceiver 205x may be a “host type” transceiver in that, to the keyboard 104x and mouse 106x, the USB device transceiver 205x appears to be the USB host 108x. The USB device transceiver 205x is configured to receive USB commands from the USB hub 204x, convert the received USB commands to non-USB commands, such as I²C, and transmit the converted non-USB commands to a user controller 206x. The USB device transceiver 205x may also be configured to receive non-USB commands from the user controller 206x, convert the received non-USB commands to USB commands, and transmit the converted commands to the remote devices via the USB hub 204x, the keyboard interface 120x and the mouse interface 122x, and the USB cables 103x.

The USB device transceiver 205x is communicably coupled to a user controller 206x, which is in turn communicably coupled to a device unit controller 208x, which is in turn communicably coupled to a BUS 211. The user controller 206x may be any standard USB device controller known in the art. The user controller 206x may be configured to emulate a USB host (e.g., the USB host 108x) so that from the view of the remote devices 104x and 106x, the keyboard 104x and mouse 106x are in direct communication with a USB host, such as USB host 108x. The user controller 206x is configured to receive the converted data from the device transceiver 205x and transmit the received data to a device unit controller 208x. The user controller 206x is communicably coupled to a device unit controller 208x. The device unit controller 208x is configured to determine the nature of the commands received from the user controller 206x and transmit the commands to the MUX 212 via the BUS 211. The device unit controller 208x may also be configured to determine if each non-USB command received from the BUS 211 is intended for the specific devices 104x and 106x attached along the same direct data path, and if so, transmit the commands to the user controller 206x.

When the device unit controller 208x transmits commands to either the BUS 211 or the user controller 206x, the device unit controller 208x may perform signal amplifying and/or reshaping on either or both of the USB data and the video device data to compensate for the increased transmission path due to the distributed KVM switch. Further, the device unit controller 208x may also determine the direction of each command or message so that the commands transmitted from the device unit controller 208x are transmitted in the correct direction.

A BUS 211 is communicably coupled to the device unit controller 208x. The BUS 211 may be any communication bus, such as an I²C bus or the like. A master controller 222 is also communicably coupled to the BUS 211. Thus, the master controller 222 is communicably coupled to the device unit controller 208x and the MUX 212 via the BUS 211. Furthermore, the master controller 222 may be communicably coupled to a video switch and to at least one user interface, such as the user interfaces labeled as the keypad 224 and the display 226.

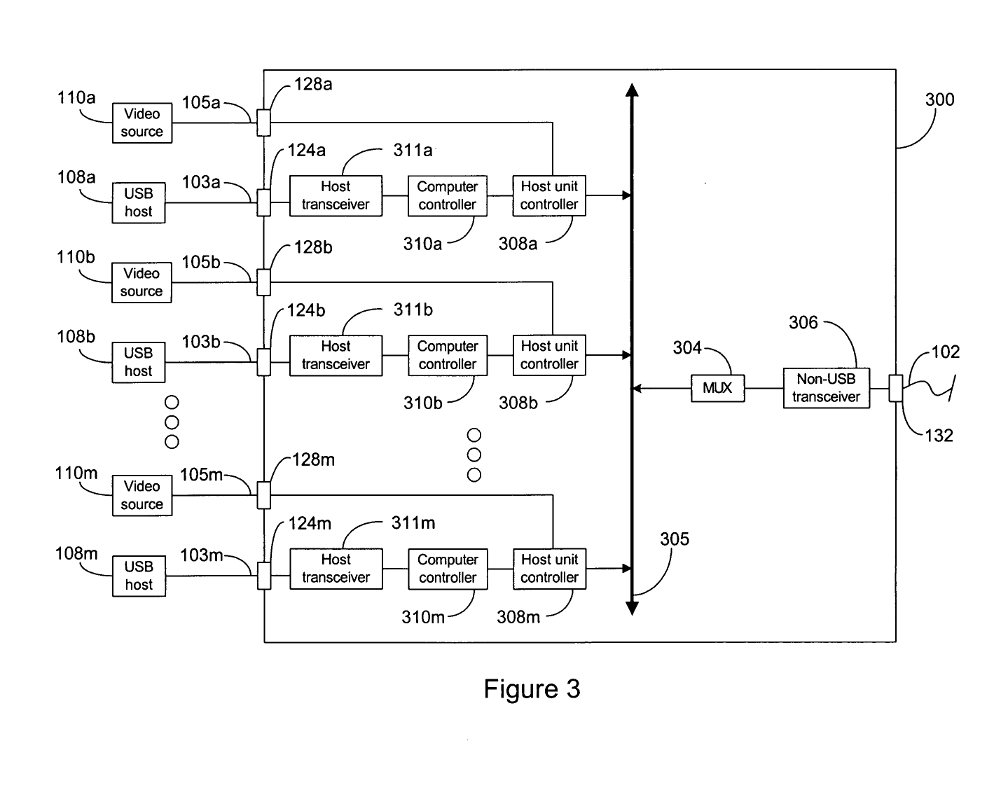

Turning now to both FIG. 2 and FIG. 3, the master controller 222 controls switching. The master controller 222 is configured to interpret switching commands received from a user interface, such as the keypad 224. The master controller 222 may be configured to convert the received commands to I²C data, for example, and direct the device unit controller 208x to communicate the commands to a host unit controller 308x, via the MUX 212, a non-USB transceiver 210, the device interface 130, the non-USB communications channel 102, the host interface 132, a non-USB transceiver 306, a MUX 304, and a BUS 305. In addition, the master controller 222 may also be configured to direct the host unit controller 308x to communicate commands to a device unit controller 208x via the BUS 305, the MUX 304, the non-USB transceiver 306, the host interface 132, the non-USB communications channel 102, the device interface 130, the non-USB transceiver 210, the MUX 212, and the BUS 211.

The switching commands received from the user interface may contain identification information. Such identification information may include, for example, a user identification number corresponding to the user requesting the switch and a computer identification number corresponding to the computer to which the user wishes to connect.

The user identification information may inform the master controller 222 which device unit controller 208x will communicate with which host unit controller 308x. Thus, based on the computer information and/or user information, the master controller 222 may instruct, for example, the device unit controller 208b to communicate with the host unit controller 308a, which supervises the operation of the USB host 108a and a video transmitter 318a in the host unit 300.

It will be understood by those skilled in the art that it is possible to have multiple device unit controllers 208x in communication with the same host unit controller 308x. In such configurations, the host unit controller 308x may implement a “priority receive” and communicate with the first device unit controller 208x to begin communications—all others will be ignored until a time-out period has passed in which there have been no communications from any of the device unit controllers 208x.

The master controller 222 may also be configured to implement security features. The master controller 222 may allow and disallow certain device unit controller 208x and host unit controller 308x connections based on permissions. If the master controller 222 receives a request for a connection that is not allowed, the master controller 222 may deny the connection request and respond back to the display 226 that the connection cannot be made. Further, connections also may be password and/or biometric data protected. Upon receiving a request for a connection that is password protected, the master controller 222 may require that the appropriate password be entered. Once the correct password has been received and authenticated, the master controller 222 will transmit the commands to the appropriate device unit controller 208x and host unit controller 308x. If authentication fails, the master controller 222 may deny the request or offer another chance to re-enter the correct password.

Also coupled to the BUS 211 is a MUX 212. The MUX 212 performs multiplexing/demultiplexing functions and may use any multiplexing/demultiplexing technology known in the art. The MUX 212 functions to combine data signals located on the BUS 211 from the device unit controllers 208x and the master controller 222 in order to send the information to the host unit 300 over the non-USB communications channel 102. The MUX 212 may also receive data sent by the host unit 300 via the non-USB communications channel 102 and separate the information into the different data signals that were combined by the MUX 304 in the host unit 300. In an exemplary embodiment, the USB data is sent over a single pair of the non-USB communications channel.

Depending on the type of video extension used, the MUX 212 may also function to separate video data signals from one another and/or from data signals. The various ways to separate and combine multiple sources of data for transmission is obvious to one having ordinary skill in the art.

The non-USB transceiver 210 is configured to receive non-USB commands from the host unit 300 via the non-USB communications channel 102 and the device interface 130 and transmit the non-USB commands to the MUX 212. The non-USB transceiver 210 may also be configured to receive non-USB commands from the MUX 212 and transmit the received commands to the host unit 300. Because the shape of the incoming signal from the host unit 300 can be distorted by the extended travel path, the non-USB transceiver 210 may also function to correct signal distortion and degradation. In addition, the non-USB transceiver 210 may also perform signal amplifying functions in order to compensate for the extended data path along the non-USB communications channel 102. Each of the device transceivers 205x, user controllers 206x, the device unit controllers 208x, the master controller 222, and the MUX 212 may be a control circuit implemented as one or combinations of the following: programmable circuit, integrated circuit, memory and I/O circuits, an application specific integrated circuit, microcontroller, complex programmable logic device, field programmable gate arrays, other programmable circuits, or the like. In addition, the device transceiver 205x, user controller 206x, and device unit controller 208x may be implemented as a single controller.

Turning next to FIG. 3, once the information from the device unit controllers 208x and the master controller 222 is combined by the MUX 212, the data is sent through the non-USB communications channel 102 to a non-USB transceiver 306 in the host unit 300. The non-USB transceiver 306 is configured to receive non-USB commands from the device unit 200 via the non-USB communications channel 102 and the host interface 132 and transmit the non-USB commands to the MUX 304. The non-USB transceiver 306 may also be configured to receive non-USB commands from the MUX 304 and transmit the received commands to the device unit 200 via the non-USB communications channel 102. Because the shape of the incoming signal from the device unit 200 can be distorted by the extended travel path, the non-USB transceiver 306 may also function to correct signal distortion and degradation. In addition, the non-USB transceiver 306 may also perform signal amplifying functions in order to compensate for the extended data path along the non-USB communications channel 102.

A MUX 304 is communicably coupled to the non-USB transceiver 306. The MUX 304 performs multiplexing/demultiplexing functions and may use any multiplexing/demultiplexing technology known in the art. The MUX 304 receives data from the non-USB transceiver and separates the information into the different data signals that were combined by the MUX 212 in the device unit 200. The MUX 304 may also function to combine data signals located on the BUS 305 from the host unit controllers 308x in order to send the information to the device unit 200 over the non-USB communications channel 102.

The data signals received from the device unit 200 are placed on the BUS 305, connected to the MUX unit 304, to be received by a host unit controller 308x. A host unit controller 308x is communicably coupled to the MUX 304 via the BUS 305. The host unit controller 308x may be configured to determine the nature of the non-USB commands received from the computer controller 310x and to transmit the commands to the non-USB transceiver 306 via the MUX 304. Further, the host unit controller 308x may also determine the direction of each command or message so that the commands transmitted from the host unit controller 308x are transmitted in the correct direction.

The host unit controller 308x may function to decode or calculate the commands from the master controller 222 on the BUS 305 in order to determine which messages/commands from the device unit controllers 208x are intended to be received by the USB host 108x. The commands from the master controller 222 may be a separate stream of data from the information from the device unit controllers 208x or an integrated part of the data from each device unit controller 208x. The information from the master controller 222 tells which USB devices 104x and 106x are trying to link to which USB host 108x, and may also tell which video source 110x should link to which display 112x. The host unit controller 308x may also prevent, if the USB host 108x is silent, the transmission of video data from the video source 110x.

A computer controller 310x is communicably coupled to the host unit controller 308x. The computer controller 310x may be configured to emulate a USB device (e.g., the remote devices 104x and 106x) so that to the USB host 108x, the USB host 108x appears to be in direct communication with a USB device. The computer controller 310x is configured to receive non-USB commands from the host tranceiver 311x and send them to the host unit controller 308x. The computer controller 310x may also be configured to receive non-USB commands and to transmit them to the host transceiver 311x. The computer controller 310x may also prevent, if the USB host 108x is silent, the transmission of video data from the video source 110x.

The USB host transceiver 311x is communicably coupled to the computer controller 310x and may be a circuit implementing the physical layer for the transmission protocol, such as a USB 2.0 PHY or the like. The USB host transceiver 311x may be a “device type” transceiver in that, to the USB host 108x, the USB host transceiver 311x appears to be the keyboard 104x and the mouse 106x. The USB host transceiver 311x is configured to receive non-USB commands from the computer controller 310x, convert the non-USB commands to USB commands, and to transmit the USB commands to the USB host 108x via the USB host interface 124x and the USB cable 103x. The USB host transceiver 311x may also be configured to receive USB commands from the USB host 108x, convert the USB commands to non-USB commands, and to transmit the non-USB commands to a computer controller 310x.

Each of the computer controller 310x, the host unit controller 308x, and the MUX 304 may be a programmable circuit, memory and I/O circuits, an application specific integrated circuit, microcontroller, complex programmable logic device, field programmable gate arrays, other programmable circuits, or the like. In addition, the computer controller 310x, the host unit controller 308x, and the host transceiver 311 may be implemented as a single controller.

Turning now to the video device data path, beginning with FIG. 2, the device unit 200 is connected to a display 112x via a video communications channel 105x. More specifically, the display 112x may be communicably coupled to the device unit controller 208x via the display interface 126x and the video communications channel 105x. The device unit controller 208x may therefore be further configured to receive video device data from the display 112x and control the flow of the received video device data. The device unit controller 208x may be configured to convert the received video device data into another data format, such as I²C and place the converted data on the BUS 211.

Using video device data, such as DDC, a display, such as the display 112x, can directly communicate with a video source, such as the video source 110x. In other words, a graphical adapter can receive from the monitor all the information about its features and consequently, a graphical adapter is capable of automatic configuration for optimized refresh values depending on the resolution used.

Communicably coupled to the BUS 211 is the master controller 222, which is in turn communicably coupled to a video switch (not shown). The video switch function to switch the video image data between video interfaces. Accordingly, the video switch is communicably coupled to at least one of the video interfaces 126x and is configured to switch the video interfaces 126x between host video interfaces 128x.

The BUS 211 is also communicably coupled to the MUX 212, which may function to combine the video device data with the USB data received from the mouse 106x and keyboard 104x. The combination of data may be determined by information received from the master controller 222. In addition, this combination may be multi-layered in that video device data from display 112a may be combined with USB data from the keyboard 104a and mouse 106a. This combined data may also be combined with other combined data from, for example, keyboard 104b, mouse 106b, and display 112b. The order of combination may also be reversed. In an exemplary embodiment, the data is combined by time multiplexing the data.

The host unit 300 is configured to receive video device data combined with converted USB data from the device unit 200 via the non-USB communications channel 102. The information sent by the MUX 212 in the device unit 200 is received by the MUX 304 in the host unit 300 via the non-USB communications channel 102 and the non-USB transceivers 210 and 306. The MUX 304 may function to separate the signals combined by the MUX 212, which may include converted USB data and video device data from multiple sources.

Once the video device data is separated, the MUX 212 sends the video device data to the host unit controller 308x via the BUS 305. The host unit controller 308x to which the video device data is sent may be determined from information from the master controller 222, in the same manner that the destination host unit controller 308x for the USB data is determined.

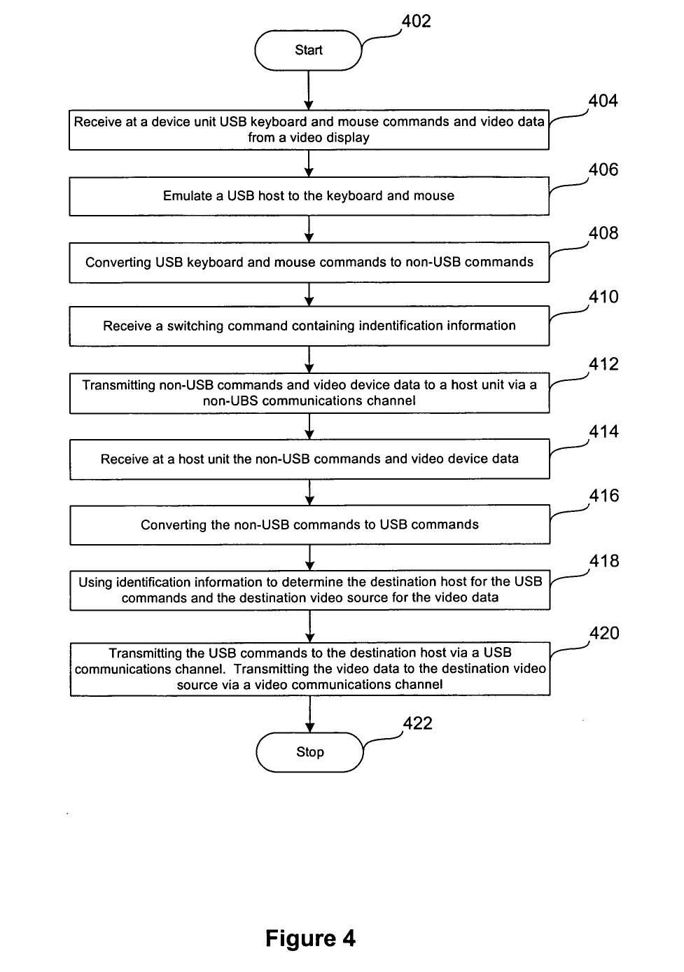

Turning next to FIG. 4, a flow chart generally illustrating part of the data flow when switching, over an extended distance, at least one keyboard interface, at least one mouse interface, and at least one video interface between host interfaces is provided. The basic flow commences at start block 402, from which progress is made to process block 404.

At process block 404, USB keyboard and mouse commands and video data from a video display are received at a device unit, such as the device unit 200. Flow then continues to process block 406, wherein a USB host, such as a host 108x, is emulated to the each of the keyboard and mouse interfaces, such as the keyboard interface 104x and mouse interface 106x.

Flow then continues to process block 408 wherein the USB keyboard and mouse commands received at the device unit are converted to non-USB commands. Flow then progresses to process block 410 wherein a switching command is received. The switching command may be received at a controller, such as the master controller 222 and may be received via at least one user interface, such as the keypad 224 and display 226. In addition, the switching command may contain identification information which is used to identify the hosts or keyboard and mouse devices which are to be in communication.

At process block 412, the converted commands and video device data are transmitted to the host unit via a non-USB communications channel, such as the non-USB communications channel 102. Flow then progresses to process block 414 wherein the non-USB commands and video data are received at the host unit.

Progression then flows to process block 416 wherein the non-USB commands are converted to USB commands. At process block 418, identification information is used to determine the destination host for the USB commands and the destination video source for the video data. The identification information may be included with the non-USB commands and video device data transmitted over the non-USB communications channel or may originate from a user-invoked switching command.

Flow then continues to process block 420, wherein the USB commands and video device data are transmitted to a destination host and video source, such as the host 108x and video source 110x, via a USB communications channel, such as a USB communications channel 103x, and via a via a video communications channel, such as a video communications channel 105x, respectively.

Flow then continues to termination block 422.

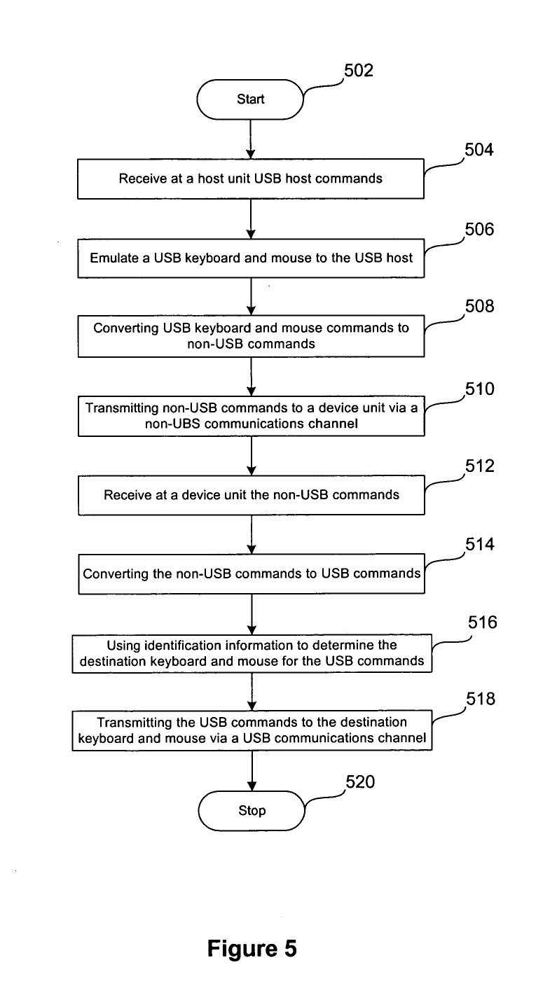

Turning next to FIG. 5, a flow chart generally illustrating another part of the data flow when switching, over an extended distance, at least one keyboard interface, at least one mouse interface, and at least one video interface between host interfaces is provided. The basic flow commences at start block 502, from which progress is made to process block 504. At process block 504, USB commands are received at a host unit, such as host unit 300, from a USB host, such as a USB host 108x.

Progression then continues to process block 506, wherein a USB keyboard and mouse are emulated to the USB host so that to the USB host, the USB host appears to be in direct communication with a USB keyboard and mouse.

Progression then flows to process block 508 wherein the USB commands are converted into non-USB commands suitable for transmission over a non-USB communications channel, such as non-USB communications channel 102.

Progression then continues to process block 510 wherein the non-USB commands are transmitted to a device unit via a non-USB communications channel (e.g., non-USB communications channel 102). At process block 512, the non-USB commands are received at a device unit, such as device unit 200.

Flow then continues to process block 514 wherein the received non-USB commands are converted to USB commands suitable for transmission to a USB keyboard and mouse. Progression then flows to process block 516 wherein identification information is used to determine the destination USB keyboard and mouse for the USB commands. The identification information may originate from a user-invoked switching command and may come from the switching command received at process block 410 of FIG. 4.

Flow then continues to process block 518 wherein the USB commands are transmitted to a USB keyboard and mouse, such as a keyboard 104x and mouse 106x, via a USB communications channel, such as a USB communications channel 103x. Progression then flows to termination block 520.

While the present invention has been described in association with several exemplary embodiments, the described embodiments are to be considered in all respects as illustrative and not restrictive. Such other features, aspects, variations, modifications, and substitution of equivalents may be made without departing from the spirit and scope of this invention which is intended to be limited solely by the scope of the following claims. In addition, the order of events in the flow charts is not to be construed as restrictive. Those skilled in the art will understand that the order may be changed without departing from the scope of the invention. Also, it will be appreciated that features and parts illustrated in one embodiment may be used, or may be applicable, in the same or in a similar way in other embodiments.

1. A distributed KVM switch comprising:
a host unit communicably coupleable to a non-USB channel and at least one USB host and video source, the host unit comprising a plurality of sets of host interfaces, each set of host interfaces having a host keyboard and mouse interface and a host video interface;
a device unit communicably coupleable to the non-USB channel and at least one USB keyboard and mouse and video display, the device unit comprising a plurality of sets of KVM interfaces, each set of KVM interfaces having a USB keyboard and mouse interface and a video interface; and
a master controller configured to switch at least one of the sets of KVM interfaces among the host interfaces;
wherein a USB host is emulated to each of the USB keyboard interfaces and mouse interfaces; and
wherein a USB keyboard and mouse are emulated to the host interface.

2. The distributed KVM switch of claim 1 further comprising a host controller in the host unit for controlling data flow and a device controller in the device unit for controlling data flow.

3. The distributed KVM switch of claim 1 further comprising:
at least one user controller communicably coupleable to at least one of the USB keyboard and mouse interfaces, the user controller being configured to emulate a USB host; and
at least one computer controller communicably coupled at least one of the sets of host keyboard and mouse interfaces, the computer controller being configured to emulate a USB keyboard and mouse.

4. The distributed KVM switch of claim 3 wherein the host controller and the at least one computer controller are the same controller.

5. The distributed KVM switch of claim 3 wherein the device controller and the at least one user controller are the same controller.

6. The distributed KVM switch of claim 3 wherein the at least one user controller and the at least one computer controller are communicably coupleable via at least the non-USB channel.

7. The distributed KVM switch of claim 3 wherein the master controller is configured to select which of the at least one user controllers and the which of the at least one computer controllers will communicate with each other.

8. The distributed KVM switch of claim 1 wherein the master controller is configured to control switching based on received user identification information and computer controllers based on computer identification information.

9. The distributed KVM switch of claim 1 further comprising a video switch communicably coupled to at least one of the video interfaces and configured to switch the video interfaces between the host video interfaces.

10. The distributed KVM switch of claim 9 wherein the video switch is communicably coupled to the master controller.

11. The distributed KVM switch of claim 1 wherein the distributed KVM switch is compatible with both USB 1.x and USB 2.x.

12. The distributed KVM switch of claim 1 further comprising a user interface selected from the group consisting of: buttons, RS232 commands, Ethernet, remote toggle switch, on-screen display, and combinations thereof.

13. The distributed KVM switch of claim 1 wherein the host unit and device unit each comprise a non-USB to USB signal converter for converting USB signals to non-USB signals and a USB to non-USB signal converter for converting non-USB signals to USB signals.

14. The distributed KVM switch of claim 13 wherein the host unit and device unit each comprise a non-USB transceiver for transmitting and receiving non-USB data over the non-USB communications channel.

15. The distributed KVM switch of claim 13 wherein the USB to non-USB converter and the non-USB to USB converter of the host unit are the same converter and the USB to non-USB converter and the non-USB to USB converter of the device unit are the same converter.

16. The distributed KVM switch of claim 1 wherein video device data is combined with USB data and transmitted from the device unit to the host unit.

17. The distributed KVM switch of claim 1 wherein the non-USB channel is a four-pair communications channel.

18. The distributed KVM switch of claim 17 wherein video image data is transmitted on three pairs of the non-USB communications channel and USB data is transmitted on one pair of the non-USB communications channel.

19. The distributed KVM switch of claim 17 wherein video device data is time multiplexed with USB data and transmitted on one pair of the non-USB communications channel.

20. A distributed KVM assembly comprising:
a switch according to claim 1; and
a non-USB channel;
wherein the host unit and the device unit are communicably coupled to the non-USB channel.

21. A distributed KVM switch comprising:
a host unit communicably coupleable to a four pair non-USB channel and at least one USB host and video source, the host unit comprising:
a plurality of sets of host interfaces, each set of host interfaces having a host keyboard and mouse interface and a host video interface,
at least one computer controller communicably coupleable to at least one of the sets of host keyboard and mouse interfaces, the computer controller being configured to emulate a USB keyboard and mouse, and
a host controller configured to control data flow over the non-USB channel;
a device unit communicably coupleable to the non-USB channel and at least one USB keyboard and mouse and video display, the device unit comprising:
a plurality of sets of KVM interfaces, each set of KVM interfaces having a USB keyboard and mouse interface and a video interface,
at least one user controller communicably coupleable to at least one of the USB keyboard and mouse interfaces, the user controller being configured to emulate a USB host, and
a device controller configured to control data flow over the non-USB channel;
a video switch communicably coupleable to at least one video interface and to at least one host video interface and configured to switch the video interfaces between the host video interfaces; and
a master controller communicably coupleable to the video switch and configured to switch at least one of the sets of keyboard, mouse and video interfaces between the host interfaces.

22. The distributed KVM switch of claim 21 wherein the master controller is configured to direct a selected user controller and the selected computer controller to communicate with each other.

23. The distributed KVM switch of claim 21 wherein the distributed KVM switch is compatible with both USB 1.x and USB 2.x.

24. A method for switching keyboard, mouse and video signals over an extended distance between a video source and a monitor and between a host device and a keyboard and mouse, the method comprising:
receiving at a device unit USB keyboard and mouse commands;
receiving at a device unit video data from a video display;
emulating a USB host to the keyboard and mouse;
receiving a switching command at a master controller, the switching command containing identification information;
converting the received keyboard and mouse commands to a non-USB format suitable for transmission over a non-USB communications channel;
transmitting to a host unit the non-USB commands and video data via a non-USB communications channel;
receiving at the host unit the converted commands and video data via the non-USB communications channel;
converting the commands received via the non-USB communications channel to USB commands for transmission over a USB communications channel;
using the identification information to determine the destination host for the USB commands and the destination video source for the video data;
transmitting the USB commands to a USB host via a USB communications channel; and
transmitting the video data to a video source via a video communications channel.

25. The method of claim 24 further comprising emulating a keyboard and mouse to the USB host.

26. The method of claim 24 further comprising:
receiving at a host unit USB commands from a USB host;
emulating a USB keyboard and mouse to the USB host;
converting the received USB commands to a non-USB format suitable for transmission over a non-USB communications channel;
transmitting to a device unit the non-USB commands via a non-USB communications channel;
receiving at the device unit the converted video data via the non-USB communications channel;
converting the non-USB data received via the non-USB communications channel to USB data for transmission over a USB communications channel;
using identification information to determine a destination USB keyboard and mouse for the USB data; and
transmitting the USB data to the destination USB keyboard and mouse via a USB communications channel.
